(19) United States
(12) Patent Application Publication
(10) Pub. No.: US 2008/0205370 A1
(43) Pub. Date: Aug. 28, 2008

(54) Method for Controlling Use Amount of Radio Channel in Ad Hoc Network and Communication Apparatus Using the Same

(76) Inventors: Hyung-Deug Bae, Daejeon-city (KR); Nam-Hoon Park, Daejeon-city (KR); Jee-Hwan Ahn, Daejeon-city (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/913,663

(22) PCT Filed: Jul. 21, 2006
(86) PCT No.: PCT/KR2006/002870

§ 371 Date: Nov. 5, 2007

(30) Foreign Application Priority Data
Jul. 21, 2005 (KR) 10-2005-0066361

(51) Int. Cl. H04J 3/00

(52) U.S. Cl. 370/345

(57) ABSTRACT

The method for controlling a use amount of a radio channel for transmitting a packet from a node in a wireless Ad Hoc network that employs a contention-based protocol includes (a) estimating a total amount of data transmitted through packet transmission from the node; (b) controlling a backoff time that determines the use amount of the radio channel based on the estimated amount of transmitted data; and (c) participating in contention for gaining access for the next packet transmission by using the backoff time. A contention window value for setting the bounds of backoff time can be set by calculating a total amount of data transmitted through a transmit node, and thus channel distribution can be controlled such that a plurality of transmit nodes can fairly transmit data through the channel, thereby enhancing quality of packet data service.

### TECHNICAL FIELD

The present invention relates to a method for controlling sharing of radio channels in a wireless Ad Hoc network and a communication apparatus using the same. More particularly, when transmitting a packet in a wireless Ad Hoc network, a node periodically estimates a transmitted data amount and controls the use amount of a radio channel in accordance with the estimated result to thereby provide fair channel sharing in the wireless Ad Hoc network.

### BACKGROUND ART

Recently, a high-speed communication network technology based on an optical communication network and a wireless communication network technology using a wireless terminal that provides mobility has become a main issue of the current communication technology.

Wireless communication network technology can be divided into a wireless calling service that places priority on voice call transmission and a wireless data service that places priority on data transmission.

In particular, as many wireless communication network subscribers who want to use mobile Internet services request wireless data service, the wireless communication network technology has attracted international interest, and particularly, a wireless local area communication network technology called wireless fidelity (Wi-Fi) or wireless local area network (WLAN) is being studied in many communication-related companies of the world. However, many companies developed wireless local area communication networks using unique protocols, and accordingly compatibility between wireless local area communication networks developed by different companies could not be established. Therefore, in 1990, the IEEE 802.11 committee was established and it specified a standard protocol for wireless local area communication networks.

A basic media access method for the wireless local area communication network proposed by the IEEE 802.11 employs a carrier sense multiple access (CSMA) protocol. CSMA is used to sense a channel before data transmission in order to initiate the data transmission only when the channel is available. That is, the data transmission is initiated when a transmit channel is idle for longer than a specified period of time called a Distributed coordination function Inter Frame Space (DIFS) time. Otherwise, when there is data transmission by another node through the transmit channel during the DIFS time, a node wanting to transmit data defers its transmission and waits until the channel is idle.

In the wireless local area communication network, collision avoidance (CA) is used in addition to the CSMA in order to avoid a plurality of communication apparatuses (hereinafter, referred to as nodes) transmitting data at the same time. To avoid collision of data transmission, the CA is used to control the node wanting to transmit data to wait for the DIFS time and an additional backoff time to transmit the data. Herein, the additional backoff time is randomly chosen within the bounds of a contention window (CW). As a result of the random choice of the backoff time, a node having the shortest additional backoff time will gain access for transmission. Among all nodes participating in the wireless local area communication network, the node that gains access for the next transmission is determined in accordance with additional backoff times of the respective nodes, and this scheme is called a contention-based distributed coordination function (DCF).

In addition to the DCF, a node can gain access for data transmission from an access point (AP) based on a contention-free method in the wireless local area communication network. Herein, the AP that grants access for transmission to the node is called a point coordinator, and a method with which the point coordinator grants the access for data transmission is called a point coordinator function (PCF).

On the other hand, a temporary network connection can be established by mobile nodes without going through an access point in an area where a network infrastructure does not exist or is destroyed. A wireless network with such a configuration is called an Ad Hoc network

That is, data transmission in the Ad Hoc network can be achieved by using the DCF rather than using the PCF since no access point exists in the Ad Hoc network.

FIG. 1 is a schematic diagram of a wireless Ad Hoc network connected to the Internet.

In an IEEE 802.11-based wireless Ad Hoc network, a node may upload or download data by accessing a wired network server. As shown in FIG. 1, the wireless Ad Hoc network is formed with two Ad Hoc nodes connected through a multi-hop link. One of the two Ad Hoc nodes is formed by a first wireless node uploading data by accessing a remote server through a second wireless node, a gateway, and the Internet, and the other is formed by a fourth wireless node downloading data by accessing the remote server through a third wireless node, the gateway, and the Internet. The gateway makes connections between the wired network and the wireless ad-hoc nodes.

In such a DCF-based wireless Ad Hoc network, the first mobile node monopolizes a channel linked to the gateway, the Internet, and the remote server when transmitting data to the remote server, and thus the fourth mobile node has to wait until data transmission of the first mobile node is finished. That is, the monopolized use of the radio channel may cause a significant unfairness in the wireless Ad Hoc network.

To solve the above problem, a congestion window value of a TCP is set in the range of 2 to 4 in order to slow down a packet transmission speed such that unfairness between TCP connections can be somewhat reduced according to the prior art. However, such a method that uses the congestion window controls data transmission in accordance with a stop-and-wait scheme, and it accordingly has a drawback of reducing overall throughput.

Korean Patent No. 2003-0009637 (entitled “Quality of service supporting apparatus and method for Ad Hoc wireless network”) was disclosed to solve the above-stated problems, but it supports quality of service by granting access for data transmission to a node with the highest priority and thus there still exists a problem of unfair radio channel sharing. In addition, U.S. Patent No. 2003-713430 (entitled “Method for enhancing fairness and performance in a multi-hop ad hoc network and corresponding system”) was disclosed to propose a method for enhancing fairness in a multi-hop Ad Hoc network by periodic contention synchronization information exchanges between nodes, but it still has problems of causing complexity in configuration, generating traffic, and consuming power due to the information exchange between the nodes.

In addition, a transaction “Fair Sharing of MAC under TCP in Wireless Ad Hoc networks,” published in the Proc. of IEEE MMT, October 1999, proposed a method for fair sharing of MAC by assigning the same backoff time to every packet, but this method also has a problem of reducing overall throughput.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

It is an advantage of the present invention to provide a method for controlling a use amount of a radio channel and a communication apparatus using the same by checking whether a node captures a channel for transmitting a packet or the radio channel is unfairly used and controlling the use amount of the channel accordingly in order to achieve fair channel sharing in a wireless Ad Hoc network.

### Technical Solution

In one aspect of the present invention, a method for controlling a use amount of a radio channel for transmitting a packet from a node in a wireless Ad Hoc network that employs a contention-based protocol includes (a) estimating a total amount of data transmitted through packet transmission from the node; (b) setting a backoff time that determines the use amount of the radio channel in accordance with the estimated amount of transmitted data; and (c) participating in contention for gaining access for the next packet transmission by using the backoff time.

In another aspect of the present invention, a communication apparatus for transmitting a packet in a wireless Ad Hoc network employing a contention-base protocol and controlling a use amount of a radio channel includes a transmitted data estimator for estimating a transmitted data amount; a transmitted data determiner for comparing the amount of transmitted data estimated by the transmitted data estimator with a predetermined upper threshold value and a predetermine lower threshold value; a contention window controller for setting a contention window value according to the comparison result of the transmitted data determiner; and a backoff time calculator for calculating a backoff time according to the contention window value set by the contention window controller. The communication apparatus participates in contention for gaining access for next packet transmission.

### Advantageous Effects

According to the present invention, an Ad Hoc network can be established in an area where a network infrastructure does not exist or is destroyed. Thus, when data packets are transmitted through the Ad Hoc network, a contention window value for setting the bounds of a backoff time can be set by calculating a total amount of data transmitted through the transmit node, and thus channel distribution can be controlled such that a plurality of transmit nodes can fairly transmit data through the channel to thereby enhance quality of a packet data service according to the exemplary embodiments of the present invention.

### BRIEF DESCRIPTION OF THE DRAWINGS

FIG. 1 is a schematic diagram of a wireless Ad Hoc network connected to the Internet.

FIG. 2 is a configuration diagram of a DCF protocol used in an 802.11-based wireless Ad Hoc network.

FIG. 3 is a schematic diagram of an internal configuration of a transmitting node used for controlling the use of a channel in a wireless Ad Hoc network according to an embodiment of the present invention.

FIG. 4 is a flowchart showing a method for fair channel sharing in the wireless Ad Hoc network according to an exemplary embodiment of the present invention.

### BEST MODE FOR CARRYING OUT THE INVENTION

An exemplary embodiment of the present invention will hereinafter be described in detail with reference to the accompanying drawings. Wherever possible, the same reference numbers will be used throughout the drawing(s) to refer to the same or like parts. In addition, for clarification of description, a detailed description of configurations or functions associated with the present invention will not be provided unless they are included within the sprit and scope of the present invention.

A plurality of nodes located in a wireless Ad Hoc network transmit and receive data with each other. At this time, a node transmitting data to another node is called a “transmit node” and a node receiving data from another node is called a “receive node.”

One node may become a transmit node and may also become a receive node, depending on circumstances in the wireless Ad Hoc network. In the wireless Ad Hoc network employing carrier sense multiple access (CSMA)/collision avoidance (CA), a distributed coordination function (DCF) protocol is used for data transmission between the transmit node and the receive node.

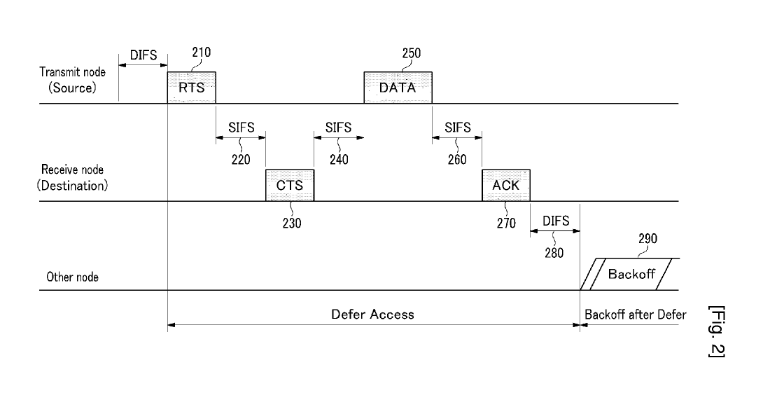

FIG. 2 is a configuration diagram of a DCF protocol used in an 802.11-based wireless Ad Hoc network.

The DCF protocol used in the wireless Ad Hoc network includes a Request To Send (RTS) 210, Short Inter Frame Spaces (SIFS) 220, 240, and 260, Clear To Send (CTS) 230, a DATA 250, an ACK 270, a DCF Inter Frame (DIFS) 280, and a Backoff 290.

The RTS 210 is a Request to Send packet that is a transmission request signal transmitted to the receive node to notify packet transmission from the transmit node. The CTS 230 is a Clear to Send packet that is a transmission response signal transmitted to the transmit node in response to the RTS 210 from the receive node.

The DATA 250 is a signal containing a packet that the transmit node wants to transmit, and the ACK 270 is transmitted to the transmit node to inform of termination of packet receiving when the receive node receives all packets included in the DATA 250.

The SIFS 220, 240, and 260 are delays for the next signal receiving between the transmit node and the receive node exchanging the RTS 210 and CTS 230, the CTS 230 and DATA 250, and the DATA 250 and ACK 270. The SIFS 220, 240, and 260 are used when the transmit node wants to transmit a packet having the highest access priority, such as voice data and image data, etc.

The DIFS 280 is the longest inter frame space, and is used for contention with the lowest priority. Herein, the contention means that a node wanting to transmit a packet using a channel checks whether another node is transmitting a packet using the same channel or checks priority of packet transmission from a plurality of nodes.

The Backoff 290 is a backoff time set for avoiding collision of packets that might be generated when one node transmits a packet and another node transmits a packet right after the previous packet transmission.

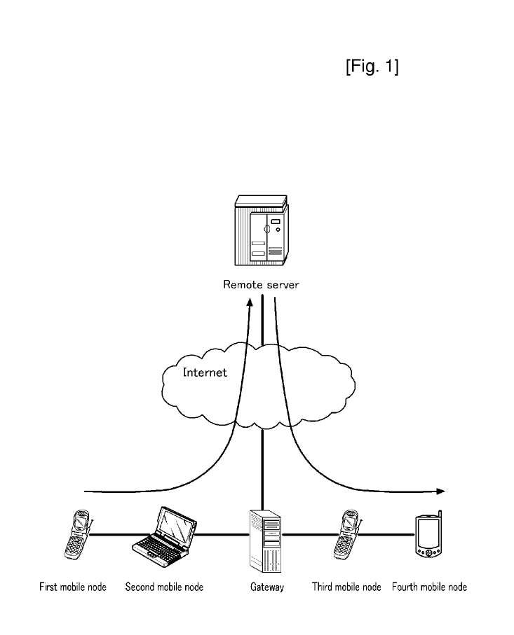

The backoff time in the wireless Ad Hoc network is determined by Math FIG. 1.

Math FIG. 1

Backoff Time=Random( )×Slot Time

where the Random( ) (random number function) has a random value between [0, CW], and an initial value of a contention window (CW) is CW_min. However, the value of CW increases to the maximum value CW_max when data transmission fails due to data collision and the like.

In addition, the slot time is the unit of time used for the backoff, and is set by a sum of a turn-on time of a transmit node, a propagation delay, and a busy checking response time, depending on physical characteristics.

The DCF protocol with such a configuration supports the local area communication in the wireless Ad Hoc network so that a plurality of nodes can transmit data packets.

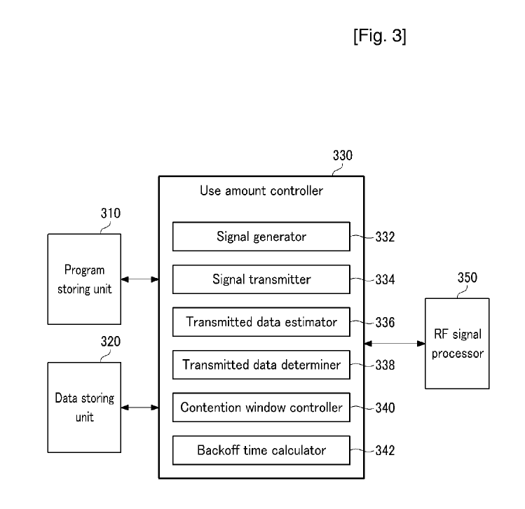

FIG. 3 is a schematic block diagram showing an internal configuration of a transmit node for controlling the use of a channel in a wireless Ad Hoc network according to an exemplary embodiment of the present invention.

The transmit node according to the exemplary embodiment of the present invention includes a program storing unit 310, a data storing unit 320, a use amount controller 330, a radio frequency (RF) signal processor 350, and an antenna 360.

The program storing unit 310 stores a control program for controlling a transmit node, a communication program for transmitting/receiving a call and data through a mobile communication network or wireless Ad Hoc network, an additional service program for providing additional services to the transmit node, and a channel use control program for controlling channel sharing according to the exemplary embodiment of the present invention.

The data storing unit 320 stores phone numbers, incoming/outgoing call lists, image files, moving image files, transmitting/receiving messages, games, and music, etc. In addition, the data storing unit 320 performs as a data buffer when the use amount controller 330 executes various programs. In addition, the data storing unit 320 stores an upper threshold value and a lower threshold value which are predetermined to compare a transmitted data amount according to the exemplary embodiment of the present invention.

The use amount controller 330 that entirely controls the transmit node estimates the amount of transmitted data, sets a CW value by comparing the estimated amount with the upper threshold value or the lower threshold value, and calculates a backoff time.

To perform the above-stated functions, the use amount controller 330 includes a signal generator 332, a signal transmitter 334, a transmitted data estimator 336, a transmitted data determiner 338, a contention window controller 340, and a backoff time calculator 342.

The signal generator 332 generates signals, RTS 210 and DATA 250, etc., which are transmitted from the transmit node. In addition, when the transmit node receives data transmitted from another node and thus the transmit node functions like a receive node, the transmit node generates CTS 230 and ACK 270.

The signal transmitter 334 transmits signals and data generated from the signal generator 332 through the RF signal processor 350 and the antenna 360.

The transmitted data estimator 336 estimates a total amount of data transmitted through the DCF protocol according to the exemplary embodiment of the present invention. Herein, the total amount of transmitted data Dtotal is obtained by Math FIG. 2.

Math FIG. 2

Dₜₒₜₐₗ=Dᵣₜₛ+D_{data}+D_{ack}

where Drts denotes a packet length (byte) of a transmitted RTS 210, Dcts denotes a packet length of a received CTS 230, Ddata denotes a packet length of a transmitted DATA 250, and Dack denotes a packet length of a received ACK 270.

That is, the total amount of transmitted data Dtotal from nodes in the wireless Ad Hoc network corresponds to a sum of packet lengths of data transmitted through the DCF protocol of the MAC layer.

The transmitted data determiner 338 compares the transmitted data amount estimated by the transmitted data estimator 336 with the upper threshold value or lower threshold value set in the data storing unit 320.

The contention window controller 340 sets a new CW value CW_new according to the comparison result of the transmitted data determiner 338. When it is determined by the transmitted data determiner 338 that the total amount of transmitted data exceeds the upper threshold value, the contention window controller 340 sets a lower value between a previous CW value CW_old multiplied by 2 and a maximum CW value CW_max value as a new CW value CW_new. When it is determined by the transmitted data determiner 338 that the total amount of transmitted data is less than the lower threshold value, the contention window controller 340 sets a greater value between a previous CW value CW_old divided by 2 and a minimum CW value CW_min as a new CW value CW_new.

The backoff time calculator 342 calculates a backoff time by using the new CW value set by the contention window controller 340 through Math FIG. 1.

The RF signal processor 350 modulates or amplifies a signal transmitted from the use amount controller 330 to an RF signal or demodulates or amplifies an RF signal received at the antenna 360, and the antenna 360 transmits a call signal or a data signal to the wireless Ad Hoc network or receives a call signal or a data signal from the wireless Ad Hoc network.

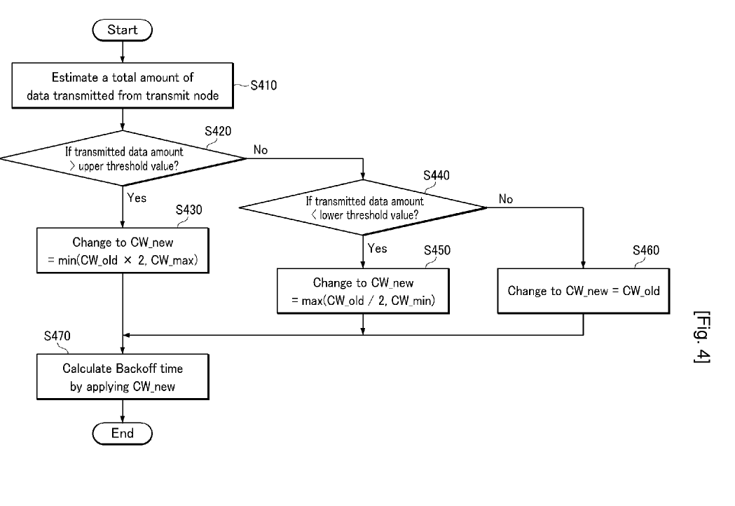

FIG. 4 is a flowchart showing a method for fair channel sharing in the wireless Ad Hoc network according to the exemplary embodiment of the present invention.

A transmit node transmitting a packet in the wireless Ad Hoc network estimates a transmitted data amount using the transmitted data estimator 336 through Math FIG. 2. At this time, the transmitted data amount is estimated at a regular interval T in step S410.

When the total amount of transmitted data Dtotal is calculated, the transmit node determines whether the calculated total amount of transmitted data Dtotal exceeds the upper threshold value by using the transmitted data determiner 338 in step S420.

When it is determined that the total amount of transmitted data exceeds the upper threshold value as a result of the determination of the transmitted data determiner 338, the contention window controller 340 sets a lower value between the previous CW value multiplied by 2 and the CW_max as a new CW value CW_new to be used for setting the range of the backoff time. As a result, the range of the backoff time is extended in step S430.

However, when it is determined that the total amount of transmitted data is less than the upper threshold value by the transmitted data determiner 338 in step S420, the transmit node checks whether the total amount of transmitted data is less than the lower threshold value by using the transmitted data determiner 338 in step S440.

When the total amount of transmitted data is less than the lower threshold value, the contention window controller 340 sets a greater value between the previous CW value CW_old divided by 2 and the CW_min as a new CW value CW_new to be used for setting the range of the backoff time. As a result, the range of the backoff time is decreased in step S450.

However, when the total amount of transmitted data is greater than the lower threshold value in step S440, that is, when the total amount of transmitted data is greater than the lower threshold value and less than the upper threshold value, the contention window controller 340 maintains the CW_new at the previous CW value CW_old in step S460.

When the CW_new is set in such a way, the backoff time calculator 342 calculates the backoff time using Math FIG. 1. At this time, the Random( ) has a random value between [0, CW_new].

Accordingly, when the backoff time is extended in step S430, the corresponding transmit node may have a lesser chance of gaining a radio channel than other transmit nodes may have, whereas the transmit node may have a greater chance of gaining the radio channel than other transmit nodes may have when the backoff time is reduced as a result of step S450. In a like manner to the above, radio channel sharing in the wireless Ad Hoc network is controlled in step S470.

According to the embodiment of the present invention, the value of CW_new is set with a smaller value between the value of CW_old multiplied by 2 and the value of CW_max, or is set with a larger value between the value of CW_old divided by 2 and the value of CW_min. However, a value for multiplying or dividing the value of CW_old may vary in the realization of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for controlling a use amount of radio channels for transmitting a packet from a node in a wireless Ad Hoc network that employs a contention-based protocol, the method comprising:
(a) estimating a total amount of data transmitted through packet transmission from the node;
(b) controlling a backoff time that determines the use amount of the radio channel based on the estimated amount of transmitted data; and
(c) participating in contention for gaining access for the next packet transmission by using the backoff time.

2. The method of claim 1, wherein, in (b),
the range of the backoff time is set to be increased when the estimated amount of transmitted data exceeds a predetermined upper threshold value, and is set to be decreased when the estimated amount of transmitted data is less than a predetermined lower threshold value.

3. The method of claim 1, wherein, in (b),
when the estimated amount of transmitted data is less than the upper threshold value and more than the lower threshold value, the range of the backoff time is set equal to a previous backoff time range.

4. The method of claim 2, wherein the range of the backoff time is increased by increasing a contention window value or is decreased by decreasing the contention window value, the contention window value determining the range of the backoff time.

5. The method of claim 4, wherein the delay time is calculated by multiplying a random variable and a slot time, the random variable having a random value between 0 and the contention window value.

6. The method of claim 4, wherein the contention window value is set a lower value between a previous contention window value multiplied by some value and a maximum contention window (CW_max) when the estimated amount of transmitted data exceeds the predetermined upper threshold value, and the contention window value set a greater value between a previous contention window value divided by some value and a minimum contention window (CW_min) when the estimated amount of transmitted data is less than the predetermined lower threshold value.

7. The method of claim 1, wherein, in (a),
the amount of transmitted data is estimated by adding a packet length of Request to Send, Cleat to Send, DATA, and ACK respectively transmitted through the contention-based protocol.

8. A communication apparatus for transmitting a packet in a wireless Ad Hoc network employing a contention-based protocol, the communication apparatus comprising:
a transmitted data estimator for estimating a transmitted data amount;
a transmitted data determiner for comparing the amount of transmitted data estimated by the transmitted data estimator with a predetermined upper threshold value and a predetermined lower threshold value;
a contention window controller for setting a contention window value according to the comparing result of the transmitted data determiner; and
a backoff time calculator for calculating a backoff time according to the contention window value set by the contention window controller,
wherein the communication apparatus participates in contention for gaining access for the next packet transmission.

9. The communication apparatus of claim 8, further comprising:
a signal generator for generating a signal for transmitting the packet;
a signal transmitter for transmitting the signal generated by the signal generator;
a data storing unit for storing the upper threshold value and the lower threshold value; and
a program storing unit for storing a channel use control program for controlling a use amount of the radio channel.

10. The communication apparatus of claim 8, wherein the contention window controller increases the contention window value when the amount of transmitted data exceeds the upper threshold value and decreases the contention window value when the amount of transmitted data is less than the lower threshold value.

11. The communication apparatus of claim 10,
wherein the contention window controller selects a lower value between a previous contention window value multiplied by some value and a maximum contention window value to increase the new contention window value and the range of the backoff time as a result, and selects a greater value between a previous contention window value divided by some value and a minimum contention window value to decrease the new contention window value and the range of the backoff time as a result.
